(19) United States
(12) Patent Application Publication
(10) Pub. No.: US 2002/0059262 A1
(43) Pub. Date: May 16, 2002

(54) Internet online group bidding system and method

(76) Inventors: Edward Hsieh, Taipei (TW); Yen Ming Lee, Taipei (TW)

Correspondence Address: BACON & THOMAS, PLLC, 4th Floor, 625 Slaters Lane, Alexandria, VA, 22314-1176, US

(21) Appl. No.: 09/768,609

(22) Filed: Jan. 25, 2001

(30) Foreign Application Priority Data
Jul. 10, 2000 (TW) 89113703

(51) Int. Cl. G06F 7/00

(52) U.S. Cl. 707/100

(57) ABSTRACT

A method of transacting Internet online group bids, which has the following steps: providing a bidding system; permitting a consumer on a connected website to enter into the bidding system via a hyperlink method, and replying with a signal back to the bidding system; displaying a merchandise web page, with the merchandise web page simulating the format of the connected website; accepting a bid given by the consumer; and comparing the bid with all other bids and selecting the proper bids.

### BACKGROUND OF THE INVENTION

1. Field of the Invention

The present invention relates to a system and method of Internet transactions, and more particularly, to an Internet online group bidding system and method.

2. Description of Related Art

Networking technology is a growth industry, and all kinds of merchandise marketing methods are available on the Internet. The purpose of all of these marketing methods is to attract more and more consumers. Therefore, in order to attract more consumers by offering preferential prices, lots of websites hold bids to determine the price for merchandise.

There are two main types of websites in this field. One is a bidding website, which deals with all kinds of bids. Another is the typical content website, such as shopping websites, search websites, etc.

The bidding website provides a place for the consumer to buy merchandise at a lower price by bidding. The bidding website has three main bidding methods: (i) group bidding: pooling a lot of consumers together to purchase an identical price of merchandise at a cheaper price; (ii) direct sale: providing merchandise at a price lower than the market price for the consumer, but the amount of merchandise may be limited; (iii) traditional bid: many consumers bid for merchandise together, with the one offering the highest price or a price higher than the base price being able to purchase the merchandise. The first two methods are used for bulk quantities of merchandise, and the third method is used for a single article of merchandise, or different types of merchandise.

On the other hand, many standard websites have increased their online bidding functionality to attract more consumers. These websites cooperate with their suppliers to hold the bid activity, thus reducing overhead expenses.

The aforementioned methods are limited for use on a single website, so each website must maintain its own member data and merchandise data. The members of one website can only bid for the merchandise provided by the website or other members. Therefore, the variety of merchandise and the number of members of each website affect the enthusiasm of the consumer to offer a bid.

### SUMMARY OF THE INVENTION

The object of the present invention is to provide an Internet online group bidding system and method to enable a plurality of consumers on different websites to bid online for an identical type of merchandise.

To achieve the object, the method of the present invention includes providing a server system for connecting a plurality of different websites; providing a database for storing merchandise browsing data, website connection data, and bid record data for each type of merchandise; transforming the arrangement format of the merchandise browsing data into a different arrangement format of each connected website; sending merchandise data to the plurality of connected websites; accepting a bid sent from a consumer on one of connected websites; comparing the bid with all other bids; and selecting and displaying proper bids.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of the environment of the Internet online group bidding system of the present invention.

FIG. 2 is a structure diagram of the Internet online group bidding system of the present invention.

FIG. 3 is a flowchart of the Internet online group bidding system of the present invention.

FIG. 4 is a picture of a website A connected to the Internet online group bidding system of the present invention.

FIG. 5 is a picture of the merchandise list web page of a connected website A.

FIG. 6 is a picture of a website B connected to the Internet online group bidding system of the present invention.

FIG. 7 is a picture of the merchandise list web page of a connected website B.

### DETAILED DESCRIPTION OF THE PREFERRED EMBODIMENT

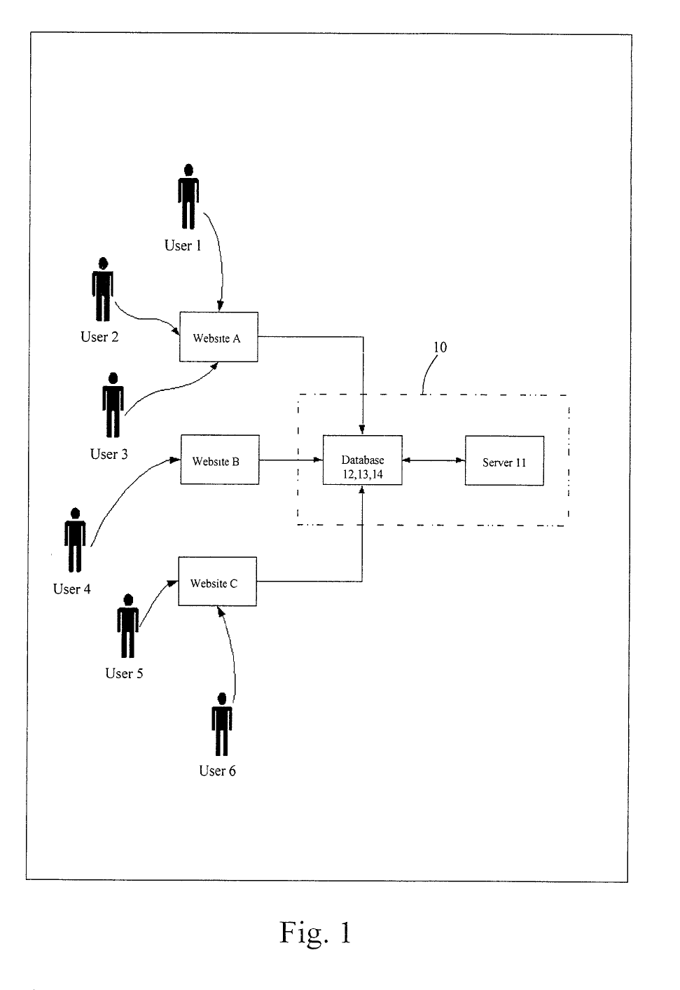

FIG. 1 is a schematic diagram of the environment of an Internet online group bidding system 10 of the present invention. The present invention provides an Internet online group bidding system, which enables a plurality of consumers on different websites to bid for an identical type of merchandise via networking technology.

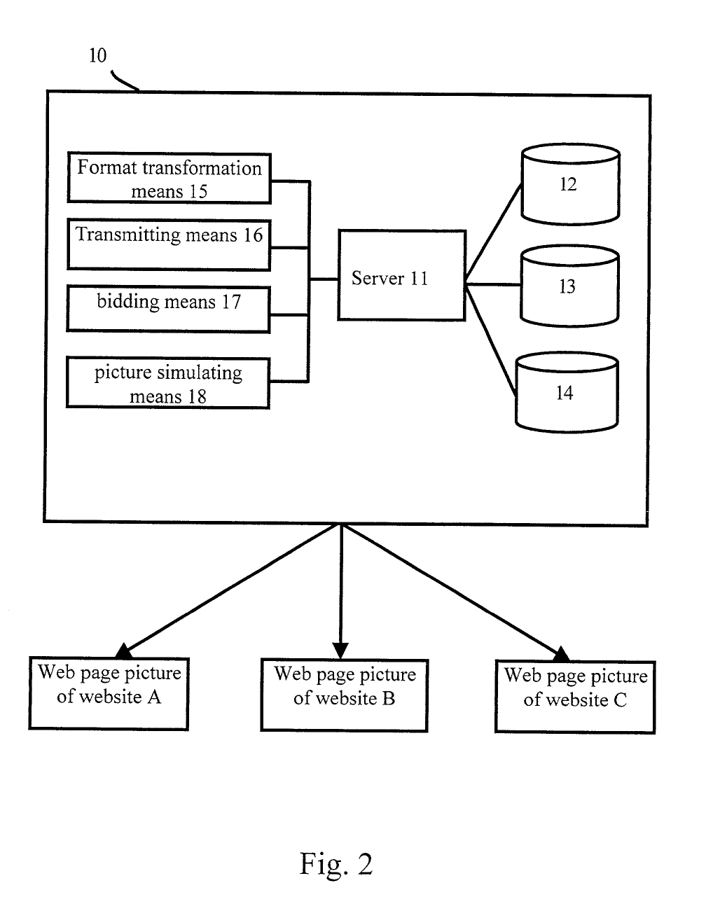

FIG. 2 is a structure diagram of the Internet online group bidding system 10 of the present invention. The Internet online group bidding system 10 comprises a server 11 for connecting to a plurality of different websites 20 and processing all associated data; a website database 12 for storing website connection data; a merchandise database 13 for storing merchandise data; a transaction database 14 for storing bid record data for each type of merchandise; a format transformation means 15 for transforming various types of merchandise data into different format types for different connected websites 20; a transmitting means 16 for sending merchandise data between the system 10 and the different connected websites 20; a bidding means 17 for receiving bids sent by the consumers on a plurality of different connected websites 20 and selecting proper bids; and a picture simulating means 18 for showing a picture displaying a plurality of different types of merchandise in a specific style, the style corresponding to a connected website style required by the different connected websites 20.

The merchandise data sent by the transmitting means 16 is the merchandise data transformed into the format of the associated website 20 by the format transformation means 15, or is the latest bid information of one type of merchandise sent to the different connected websites 20 for the consumer. The system 10 may automatically transmit the latest bid information via the transmitting means to a plurality of different connected websites 20, or the plurality of different connected websites 20 may regularly inquire for the latest bid information via the transmitting means 16 from the Internet online group bidding system 10.

Additionally, in order to stimulate the consumer and safeguard the fairness of the transaction, the Internet online group bidding system 10 can set a limiting condition to decide when to stop receiving bids, and any consumer who sends a proper bid within the limiting condition can purchase the associated merchandise. The limiting condition could be a date or a limiting number of bids placed by the consumers.

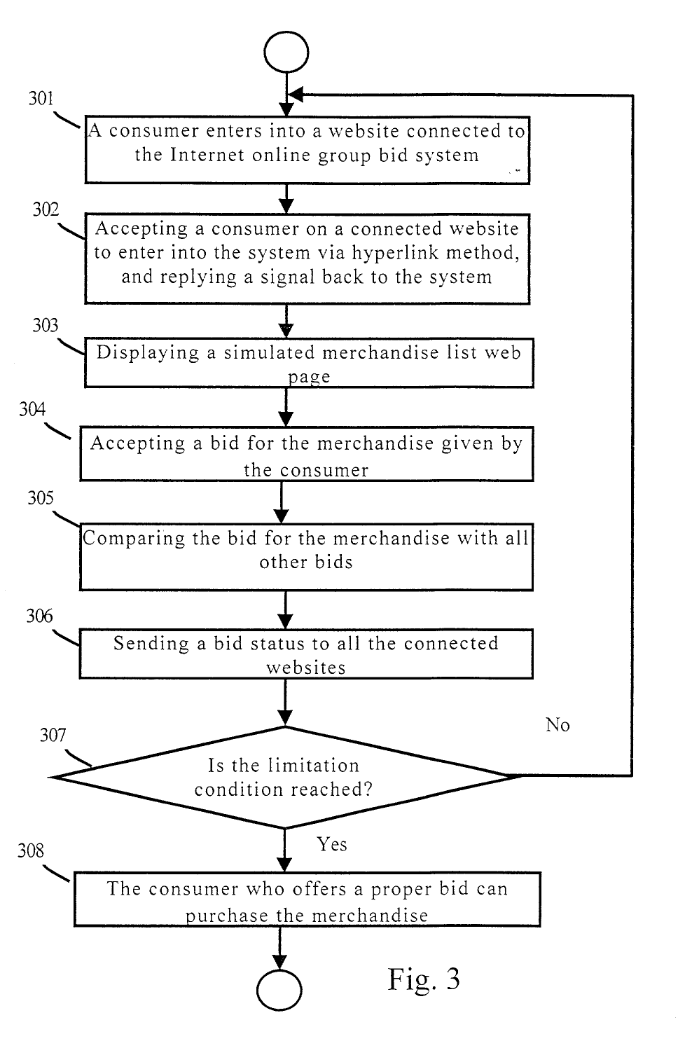

FIG. 3 is a flowchart of the Internet online group bidding system 10 of the present invention. The following are the steps of a consumer entering into a connected website 20A to bid for merchandise.

Step 301: A consumer enters the website 20A connected to the Internet online group bid system 10. The consumer could be a member of any of the connected websites 20.

Step 302: Permitting the consumer on the connected website 20A to enter into the system 10 via a hyperlink method, and replying with a signal back to the system 10. The signal indicates data about the consumer and the connected website 20A, so the system 10 can find the associated data stored in the website database 12. The format transformation means 15 of system 10 transforms the merchandise data into the format of the connected website 20A.

Step 303: Displaying a simulated merchandise list web page. According to the associated data for the connected website 20A, the picture simulating means 18 of the system 10 simulates the merchandise list web page.

Step 304: Accepting a bid for the merchandise given by the consumer. The consumer sends the bid from the connected website 20A.

Step 305: Comparing the bid for the merchandise with all other bids for that merchandise. The bidding means 17 of system 10 can decide if the bid is competitive.

Step 306: Sending a bid status to all the connected websites 20. The transmitting means 16 of the system 10 sends the latest bid status to all the connected websites 20.

Step 307: Is the limiting condition reached? If so, proceed to step 308. If not, go back to step 301. Before the limiting condition is reached, the system 10 will continue to accept bids.

Step 308: The consumer who offers a proper bid can purchase the merchandise. When the limiting condition is reached, the bidding means 17 of system 10 selects the proper bid(s).

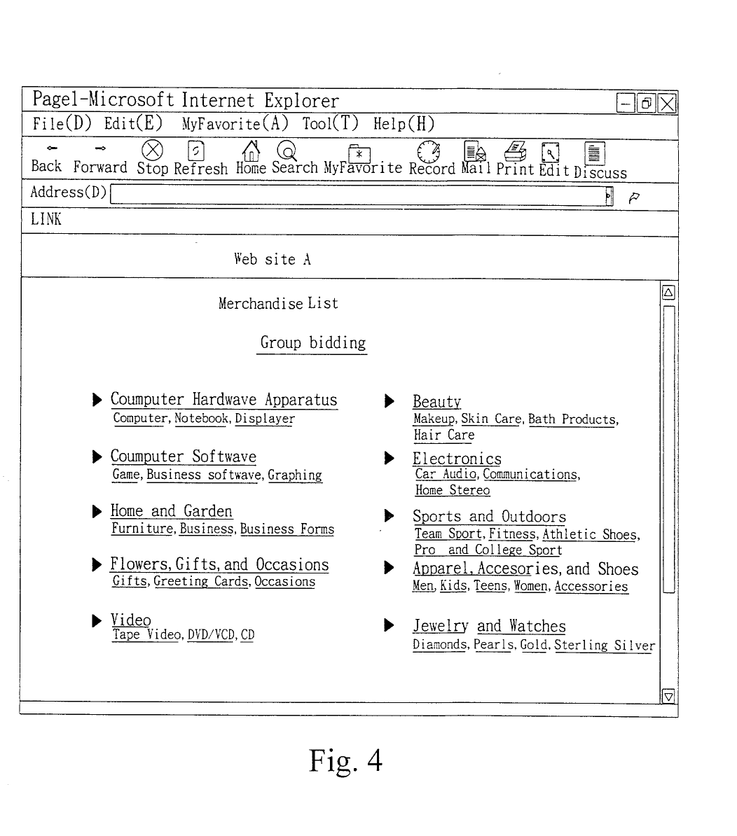

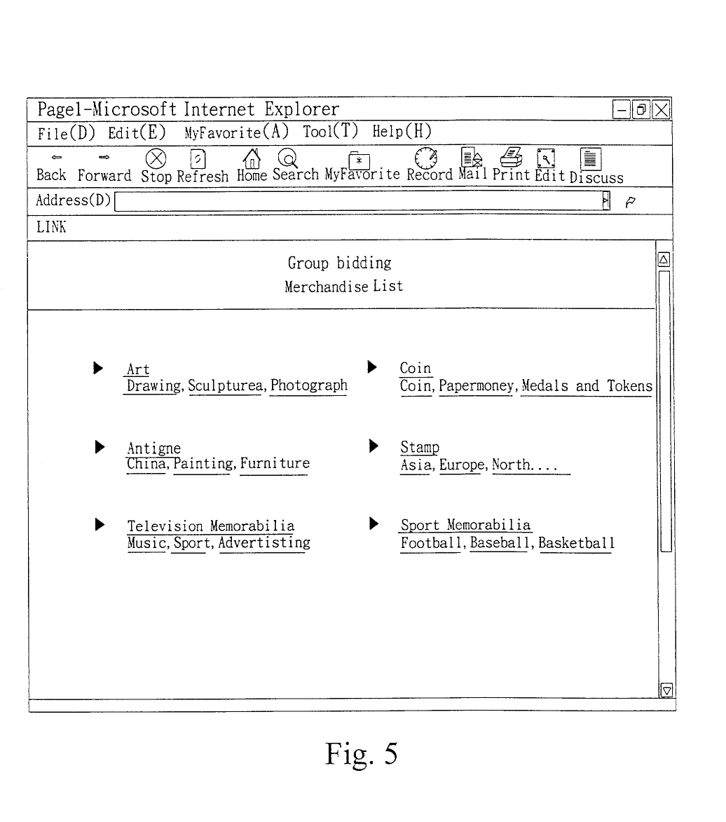

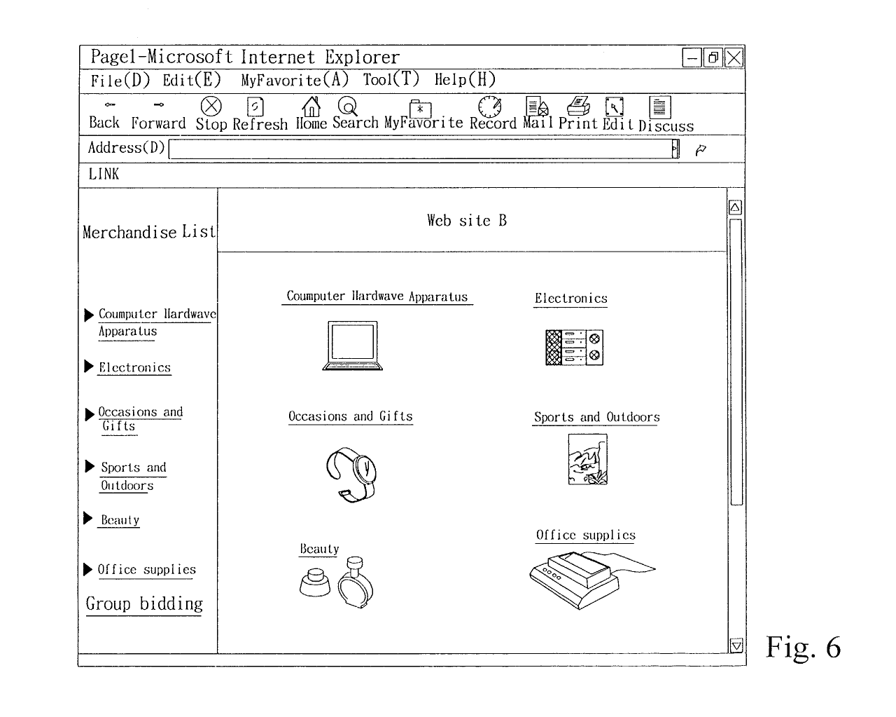

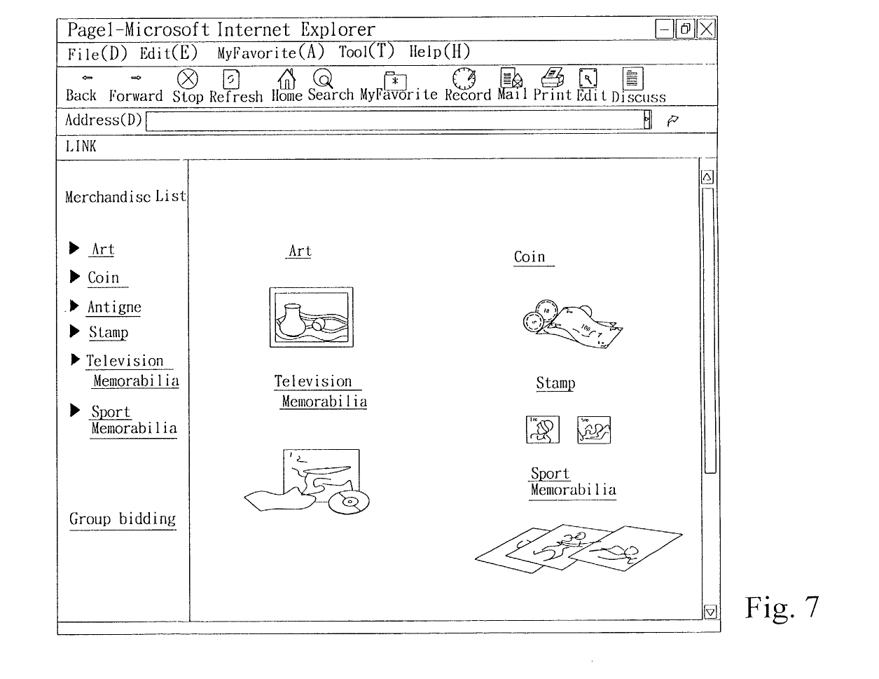

FIG. 4 is a picture of a website A connecting to the Internet online group bidding system 10 of the present invention. FIG. 5 is a picture of the merchandise list web page of the connected website A. FIG. 6 is a picture of a website B connecting to the Internet online group bidding system 10 of the present invention. FIG. 7 is a picture of the merchandise list web page of the connected website B. Each connected website 20 of the Internet online group bidding system 10 shows a “group bidding” option on the web page. When the consumer enters into any one of the connected websites 20 to login as a member and clicks on the “group bidding” option, the connected website 20 sends a signal to the server 11 of the Internet online group bidding system 10. The signal includes data about the original connected website 20 (e.g. website number), consumer data (e.g. member number), etc. The server 11 then stores all the associated data into the website database 12. The server 11 of the Internet online group bidding system 10 records the merchandise list in the XML (Extensible Markup Language) format. Since every connected website 20 has a different web page arrangement format, the server 11 uses the picture simulating means 18 to simulate all the different kinds of web page arrangement formats. As shown in FIG. 4 to FIG. 7, there are two different web page arrangement formats for the connected websites A and B. These two web pages contain the same merchandise information, but this information is shown in different arrangement formats. The actual method is as follows: the server 11 of the Internet online group bidding system 10 which original connected website 20 the consumer is on via the signal, then the format transformation means 15 utilizes XSL (Extensible Stylesheet Language)/XSLT (Extensible Stylesheet Language Transformation) technology to transform the XML merchandise list file into the arrangement format of the connected website 20. Therefore, the consumer may not even notice the change of the website linkage. The XSLT technology is used to transform the XML source code into other formats, and the XSL technology is used to provide formatting instructions to set an external form. These two technologies have the same function.

When the consumer decides to bid for merchandise that is in the merchandise list for group bidding and gives a bid price for merchandise, this bid record data will be stored in the transaction database 14 of the system 10. The bid record data includes the connected website 20 data, the consumer data (e.g. member number of connected websites 20), merchandise data (e.g. merchandise number), and the bid price.

The transaction database 14 then provides all merchandise bid records (containing the records from different consumers and connected websites 20), then the bidding means 17 compares the new bid with other bids. Finally, the transmitting means 16 sends the bid result or the latest bid information of one type of merchandise to the connected website 20, and the original connected website 20 stores these data into its own database (the member data). Thus the consumer can inquire from the personal bid record stored in the connected website 20 to know the bid result or the latest bid information.

Additionally, if the connected website 20 does not provide functionality for personal bid history recording, the consumer can also connect to the server 11 of the Internet online group bidding system 10 to inquire about the bid status. The consumer can connect to the Internet online group bidding system 10 via the connected website 20 to inquire about the personal bid record provided by the server 11, and thereby discover if the bid has won, the present rank, the limitation data, etc.

The Internet online group bidding system 10 can send an e-mail notice, a short message to consumer's mobile phone via SMS (short message service), etc. to inform the consumer automatically of the bid status (e.g. bid rank). There are two possible methods. The first is that the original connected website 20 sends an e-mail or short message to the consumer, which requires that the connected website 20 perform this function. The second is that the server 11 of the Internet online group bidding system 10 accesses the database of the connected website 20 to get the manner for contacting the associated member, and then transmits the real time bid status to the consumer according to the obtained contacting manner.

The present invention enables the different connected websites 20 to show the same group bidding merchandise in different formats. Hence, regardless of whether or not the website has its own biding system, by joining the Internet online group bidding system 10 the website 20 can increase the content and functionality of the website for the consumer. For the supplier of merchandise, joining the Internet online group bidding system 10 can expand market base. The Internet online group bidding system 10 can also classify merchandise to match up different bid modes for each website. For that reason, each connected website keeps its own bidding activity style.

Every consumer has different browsing and shopping habits, so they choose different websites to browse. The method of the Internet online group bidding system 10 does not only send merchandise data to each connected website via hyperlink technology, but also uses XML and XSL/XSLT technology to show merchandise data in the identical format of the original website. The consumer on the connected website 20 can bid for merchandise by group bidding without any change of format.

The consumer can also offer merchandise for bidding to enable a C2C (client to client) transaction model. The Internet online group bidding system also enables consumers to provide merchandise for group bidding. Additionally, each type of merchandise in group bidding need not be a single type or piece, but could be a combination of several different types of merchandise or a group of items. The Internet online group bidding system can implement different bidding systems and limitation conditions according to the different types of merchandise and websites.

Although the present invention has been explained in relation to its preferred embodiment, it is to be understood that many other possible modifications and variations can be made without departing from the spirit and scope of the invention as hereinafter claimed.

What is claimed is:

1. An Internet online group bidding system enabling a plurality of consumers on different websites to bid for an identical type of merchandise via networking technology, the system comprising:
a server for connecting to a plurality of different websites;
a website database for storing websites connection data;
a merchandise database for storing merchandise data;
a transaction database for storing bid record data for each type of merchandise;
a format transformation means for transforming a plurality of merchandise data into different format types for different connected websites;
a transmitting means for sending merchandise data between the system and the different connected websites; and
a bidding means for receiving bids sent by the consumers on a plurality of different connected websites and selecting proper bids.

2. The Internet online group bidding system of claim 1, wherein the system further comprises a picture simulating means for showing a picture displaying a plurality of different types of merchandise in a specific style, the style corresponding to a connected website style required by the different connected websites.

3. The Internet online group bidding system of claim 1, wherein the system sets a limiting condition to decide when to stop receiving the bids, and any consumer who sends a proper bid within the limiting condition can purchase the merchandise.

4. The Internet online group bidding system of claim 1, wherein the merchandise data sent by the transmitting means is the merchandise data transformed into the format of the associated website.

5. The Internet online group bidding system of claim 1, wherein the merchandise data sent by the transmitting means is the latest bid information of one type of merchandise sent to the different connected websites for the consumer.

6. The Internet online group bidding system of claim 5, wherein the system automatically transmits the latest bid information via the transmitting means to a plurality of different connected websites.

7. The Internet online group bidding system of claim 5, wherein a plurality of different connected websites inquire for the latest bid information via the transmitting means from the Internet online group bidding system regularly.

8. A method of transacting Internet online group bids, the method enabling a plurality of consumers on different websites to bid for an identical type of merchandise via net working technology, the method comprising:
providing a server system for connecting to a plurality of different websites;
providing a database for storing merchandise browsing data, a websites connection data and bid record data for each type of merchandise;
transforming the arrangement format of the merchandise browsing data into a different arrangement format of each connected website;
sending merchandise data to the plurality of connected websites;
accepting a bid sent from a consumer on one of connected websites;
comparing the bid with all other bids; and
selecting and displaying proper bids.

9. The method of transacting Internet online group bids of claim 8, wherein the method sets a limiting condition to decide when to stop receiving the bids, and any consumer sending a proper bid before the limitation condition can purchase the merchandise.

10. The method of transacting Internet online group bids of claim 8, wherein the sent merchandise data is the merchandise browsing data transformed into the format of the associated website.

11. The method of transacting Internet online group bid of claim 8, wherein the sent merchandise data is the latest bid information of one type of merchandise sent to the different connected websites for the consumer.

12. The method of transacting Internet online group bids of claim 11, wherein the system automatically transmits the latest bid information to the plurality of different connected websites.

13. The method of Internet online group bid of claim 8, wherein the plurality of different connected websites inquires for the latest bid information.

14. A method of transacting Internet online group bids, the method enabling a plurality of consumers on different websites to bid for an identical type of merchandise via networking technology, the method comprising:
providing a bidding system;
permitting a consumer on a connected website to enter into the bidding system via a hyperlink method, and replying a signal back to the bidding system;
displaying a merchandise web page, the merchandise web page is simulating the format of the connected website;
accepting a bid given by the consumer; and
comparing the bid with all other bids and selecting the proper bids.

15. The method of transacting Internet online group bids of claim 9, wherein the method further comprises sending a bid status to the different connected websites for the consumer.
